(19) United States
(12) Patent Application Publication
(10) Pub. No.: US 2012/0037122 A1
(43) Pub. Date: Feb. 16, 2012

(54) METHOD AND DEVICE FOR CONTROLLING A FUEL METERING SYSTEM FOR AN INTERNAL COMBUSTION ENGINE

(76) Inventors: Guenter Veit, Plochingen (DE); Stefan Keller, Stuttgart (DE)

(21) Appl. No.: 12/810,103

(22) PCT Filed: Nov. 14, 2008
(86) PCT No.: PCT/EP2008/065525

§ 371 Date: Oct. 31, 2011

(30) Foreign Application Priority Data
Feb. 6, 2008 (DE) 10 2008 007 668.6

(51) Int. Cl. F02M 69/54

(52) U.S. Cl. 123/457

(57) ABSTRACT

A device and a method for controlling a fuel metering system, the fuel pressure being controlled as a function of the operating state of the internal combustion engine. When the internal combustion engine is switched off, the fuel pressure is controlled at a first value. If a condition is present which is normal when the internal combustion engine is switched off, the fuel pressure is controlled at a second value.

### BACKGROUND INFORMATION

In a fuel metering system equipped with a common rail system, it is normally provided that when the internal combustion engine is switched off, the actuators which influence the fuel pressure in the high-pressure accumulator of the fuel metering system are activated in such a way that the pressure drops to atmospheric pressure.

Modern internal combustion engines are frequently equipped with a so-called automatic start/stop system. In such an automatic start/stop system, it is provided that the internal combustion engine is switched off as a function of the state of the internal combustion engine and/or the state of the driven vehicle. This normally occurs when the vehicle comes to a stop. As soon as the driver desires to continue driving and this is indicated by activating a control element, for example the gas pedal, the internal combustion engine starts automatically.

If the rail pressure in an internal combustion engine equipped with such an automatic start/stop system is reduced when the internal combustion engine is switched off, the fresh start of the internal combustion engine may possibly be delayed significantly. Furthermore, the hydraulic components are severely stressed.

### SUMMARY OF THE INVENTION

The method of the present invention makes it possible to restart the internal combustion engine very rapidly in start/stop operation. Moreover, the reduced pressure reduction/buildup cycle results in significantly less stress on the hydraulic components. According to the present invention, this is achieved in that the fuel pressure is controlled at a first value when the internal combustion engine is switched off. If a further condition is present, the fuel pressure is controlled at a second value. The second value normally corresponds to the value which is usual when the internal combustion engine is switched off. Preferably, the second value assumes the value zero or it assumes a value corresponding to atmospheric pressure. In one particularly advantageous embodiment, it is provided that the first value corresponds to a fuel pressure normally used at idle.

As a further condition, it is preferably checked if the driver activates a control element indicating the intention of shutting down the vehicle. This means that a check is made as to whether the driver intends to switch off the vehicle driven by the internal combustion engine.

If the fuel pressure falls below a threshold value, the fuel pressure is controlled at a second value. This has the advantage that the pressure does not drop below a predetermined value. If the pressure threatens to drop below the predetermined value, the consequence is that when the driver switches off the vehicle, the pressure in the rail has dropped too much and it might no longer be possible to open the pressure regulating valve. In this case, a restart of the vehicle using a cold engine will be delayed.

It is furthermore advantageous if the fuel pressure is set to an operating point-dependent value if the rotational speed rises above a specific rotational speed value.

This means that as a further condition, it is checked whether the rotational speed has risen above a threshold. If this is the case, a transition may be made to the normal activation of the actuator.

### BRIEF DESCRIPTION OF THE DRAWINGS

FIG. 1 shows a block diagram of the device according to the present invention.

FIG. 2 shows a flow chart for elucidating the method according to the present invention.

### DETAILED DESCRIPTION

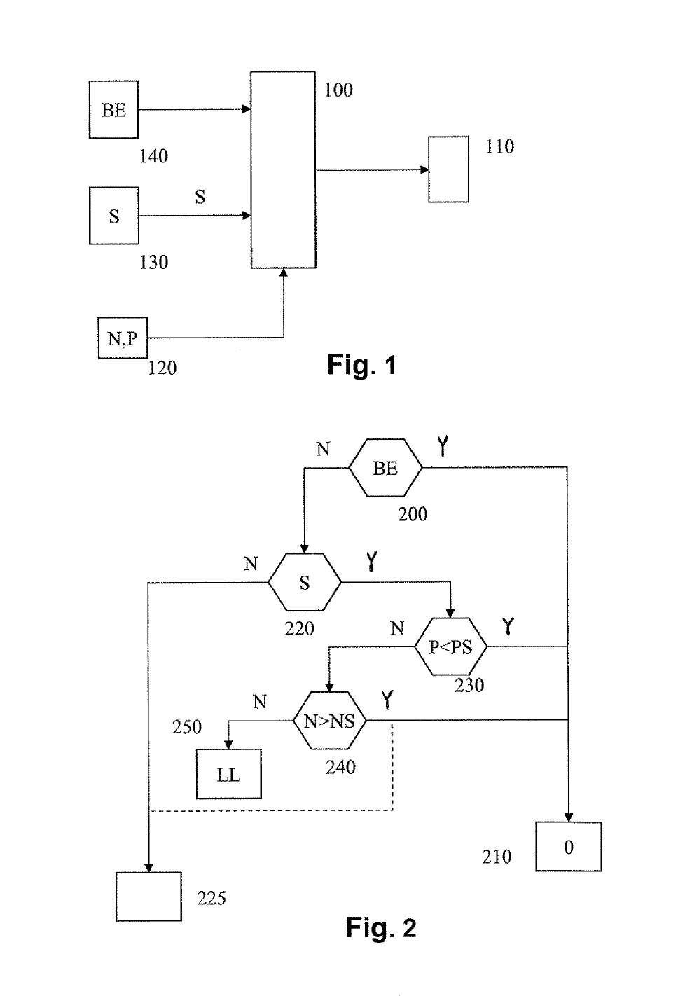

FIG. 1 shows important elements of the device according to the present invention in a block diagram. A controller is denoted as 100. The controller activates an actuator 110. Actuator 110 is an actuator that controls the pressure in a fuel system. The fuel metering system is preferably a so-called common rail system. In such a common rail system, actuator 110 may be embodied as a so-called pressure regulating valve that connects an area having high pressure with an area having low pressure. Controller 100 activates actuator 110 in such a way that the pressure in the high-pressure area assumes a specific value. In a simplified specific embodiment, it may be designed as a controller and in an improved specific embodiment as a regulator. In this case, the pressure is detected and compared with a setpoint. Actuator 110 is activated as a function of the comparison. As an alternative or in addition, a controllable high-pressure pump may be designed as an actuator for a pressure regulating valve. It may also be activated as a controller or as a regulator.

Controller 100 processes the output signals of various sensors 120. These sensors are in particular a rotational speed sensor and/or a pressure sensor, the first supplying a rotational speed signal N and the second a pressure signal P corresponding to the pressure in the high-pressure area. Furthermore, an automatic start/stop system 130 which supplies a signal S is provided. This start/stop controller is designed in such a way that it switches the internal combustion engine off under specific conditions of the vehicle and/or the internal combustion engine. For example, the internal combustion engine is switched off if the automatic start/stop system recognizes that the vehicle is not moving. If the start/stop controller recognizes that the driver intends to continue driving the vehicle, the start/stop controller starts the internal combustion engine and makes continued driving possible.

Furthermore, a control element 140 is provided which is activated by the driver and indicates if the vehicle is in operation or has been permanently stopped. This control element is in particular an ignition switch designed as an ignition key or as switching means activated by the driver. The state of this control element indicates if the driver intends to stop the vehicle permanently. It is normally provided that the vehicle is operated if control element 140 is activated. If the vehicle stops, the automatic start/stop system normally switches the internal combustion engine off. If the driver indicates through a corresponding activation of control element 140 that he intends to stop the vehicle permanently, the internal combustion engine is also switched off. This means that the internal combustion engine is switched off and on as a function of the position of the control element as well as a function of start/stop controller 130.

According to the present invention, it is provided that if the internal combustion engine is switched off via the control element, the rail pressure in the high-pressure area of the common rail system may be reduced and if the internal combustion engine is switched off via the start/stop controller, the rail pressure is not reduced but is instead left at its value or in a preferred embodiment is set to a value used at idle. As a result, the rail pressure is more rapidly available for a fresh start of the internal combustion engine and a restart is more rapidly possible.

Normally, the start/stop controller recognizes that the vehicle is stopping. In this case, actuator 110 is activated in such a way that the rail pressure does not drop. If a fresh start then occurs, the rail pressure is immediately available. If the driver activates control element 140 after the stop, this is also recognized and actuator 110 is activated in such a way that the rail pressure drops to the value normally present in a vehicle that is switched off. This value to which the rail pressure is reduced normally assumes the value zero. However, embodiments are also possible in which the rail pressure is set to a different value.

A specific embodiment of the method of the present invention is presented below based on a flow chart in FIG. 2. A first query 200 checks if control element 140 is activated in such a way that the driver intends to stop the vehicle. If this is the case, actuator 110 is activated in step 210 in such a way that the fuel pressure assumes a second value that is normally present when an internal combustion engine is switched off.

If, however, query 200 recognizes that a corresponding signal of control element 140 is not present, query 220 checks if a start/stop controller 130 emits a signal indicating that the internal combustion engine is being shut down. If this is not the case, the actuator is activated in step 225 in such a way that the fuel pressure assumes its normal value. This value is normally specified as a function of the operating state of the internal combustion engine. Preferably this is implemented by specifying a corresponding setpoint value for the rail pressure or a corresponding control value for actuator 110.

However, if query 220 recognizes that a signal of the start/stop controller is present which indicates that the internal combustion engine is being switched off, query 230 follows. This query 230 checks if another condition is present. In particular, this query 230 checks if fuel pressure P is lower than a threshold value PS. If this is the case, actuator 110 is activated in step 210 in such a way that the rail pressure is reduced to the value that is normally present when the internal combustion engine is switched off. If query 230 recognizes that value P of the rail pressure is not lower than threshold value PS, query 240 checks if rotational speed N is higher than a threshold value. If this is not the case because the rotational speed is lower than a threshold value NS, actuator 110 is activated in step 250 in such a way that the rail pressure is set to a first value. This first value is normally selected in such a way that it corresponds to the value used at idle. If the value of rotational speed N is higher than the threshold value, an activation occurs in step 210 in such a way that the fuel pressure assumes the second value. As an alternative, it could also be provided here that actuator 110 is activated in step 220 in such a way that it assumes an operating point-dependent value.

This means that if a signal is present in control element 140 indicating that the driver is switching the vehicle off, actuator 110 is activated in step 210 in such a way that the fuel pressure assumes a second value. This second value corresponds to the value that the rail pressure normally assumes if the internal combustion engine is shut down for an extended period of time. This value normally corresponds to the value of the ambient pressure.

If no signal from control element 140 indicating that the internal combustion engine is being switched off is present and start/stop controller 130 also provides no signal requesting that the internal combustion engine be switched off, actuator 110 is activated in such a way that the rail pressure assumes a third value. This third value is normally specified as a function of the operating state of the internal combustion engine, in particular the rotational speed and load of the internal combustion engine. The pressure during operation of the internal combustion engine is controlled or regulated at this third value.

If a signal of the start/stop controller causing the internal combustion engine to be switched off is present, actuator 110 is activated in such a way that the fuel pressure assumes a first value. This value is normally larger than the second value. The first value is selected in such a way that a rapid start of the internal combustion engine is made possible.

This means that when the internal combustion engine is switched off by a start/stop controller, the rail pressure is not reduced to atmospheric pressure.

In a common rail system having a pressure regulating valve, it is therefore provided that the start/stop controller does not open the pressure regulating valve when the internal combustion engine is switched off. This means that the pressure regulating valve is opened in step 210 in a common rail system having a pressure regulating valve. On the other hand, the pressure regulating valve is kept closed in steps 225 and 250.

1-6. (canceled)

7. A method for controlling a fuel metering system, comprising:
controlling a fuel pressure as a function of an operating state of an internal combustion engine, the fuel pressure being controlled at a first value if the internal combustion engine is switched off, and the fuel pressure being controlled at a second value if a condition of the fuel pressure is present which is normal when an internal combustion engine is switched off.

8. The method according to claim 7, wherein the first value is used at idle.

9. The method according to claim 7, wherein the fuel pressure is controlled at the second value if the fuel pressure falls below a threshold value.

10. The method according to claim 7, wherein the fuel pressure is controlled at the second value if a vehicle driven by the internal combustion engine is switched off.

11. The method according to claim 7, wherein the fuel pressure is set to an operating point-dependent value if a rotational speed rises above a specific rotational speed value.

12. A device for controlling a fuel metering system, a fuel pressure being a function of an operating state of an internal combustion engine, the device comprising:
means for controlling the fuel pressure at a first value when the internal combustion engine is switched off and for controlling the fuel pressure at a second value when a condition is present which is normal when an internal combustion engine is switched off.
